(19) United States
(12) Patent Application Publication
(10) Pub. No.: US 2003/0161278 A1
(43) Pub. Date: Aug. 28, 2003

(54) Symbol data converting circuit

(75) Inventor: Hiroyuki Igura, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/366,562

(22) Filed: Feb. 14, 2003

(30) Foreign Application Priority Data
Feb. 25, 2002 (JP) 2002-048380

(51) Int. Cl. H04B 7/216

(52) U.S. Cl. 370/320

(57) ABSTRACT

Provided is a symbol data converting circuit for compressing symbol data and suppressing an increase in storage capacity required of a symbol data buffer memory. The circuit includes first and second exponent value calculation circuits for outputting exponent values of the in-phase and quadrature components, respectively, of symbol data; a circuit, to which are input the exponent values of the in-phase and quadrature components of the symbol data output from the first and second exponent value calculation circuits, respectively, for selecting and outputting whichever of the two input exponent values corresponds to the component having the larger absolute value; and first and second shifters for shifting the in-phase and quadrature components, respectively, by an amount equivalent to the selected exponent value, and outputting the shifted in-phase and quadrature components, respectively. The amount of shift for the purpose of normalization is made common for both the in-phase and quadrature components by utilizing the correlation between the in-phase and quadrature components of the symbol data, and the pair of in-phase and quadrature components is converted to one exponent, a mantissa of the in-phase component and a mantissa of the quadrature component, thereby achieving compression of the symbol data.

### FIELD OF THE INVENTION

This invention relates to a digital baseband processing circuit and, more particularly, to a data converting circuit suited for reducing the amount of memory necessary for storing symbol data when such data is stored in a buffer circuit.

### BACKGROUND OF THE INVENTION

Since the number of items of symbol data necessary to be stored in a conventional symbol data buffer circuit of this kind is not that great, the symbol data is stored as is without taking any particular measures.

However, owing to recent advances in CDMA (Code Division Multiple Access) techniques, a method that has come into use is one that simultaneously receives radio waves, which have propagated over a plurality of paths and have been separated, to combine received signals. For example, when signals that have traversed respective paths are recombined after being despread individually, an adjustment is applied so as to make phases of branch signals the same, a weighting that is proportional to each of signal level of respective branches is applied to each branch signal, and the weighted signals are then added, thereby subjecting the signals to diversity combining (maximal ratio combining).

In order to compensate for a difference in delay between one path and another in implementation of this technique, a symbol data buffer memory having a large storage capacity is required. A problem which arises is an increase in the area used for the symbol data buffer circuit. For example, in a RAKE receiver that provides the diversity effect by separating multipath waves produced by multipath transmission lines and then combining the received signals appropriately, symbol data in an amount commensurate with a required delay time (path time difference) that corresponds to a plurality of paths detected by measurement of a delay profile must be stored beforehand in a buffer circuit (referred to as a “symbol data buffer circuit”). The symbol data buffer circuit accumulates symbol data temporarily and then outputs the data to compensate for the phase difference between paths.

Increases in the number of paths and in the symbol transfer rate are accompanied by an increase in the storage capacity required of the symbol data buffer.

An application of a technique that compresses the symbol data may be considered as one example of dealing with the above mentioned problem.

An example of a technique for reducing storage capacity necessary for storing data has been described in the specification of Japanese Patent Kokai Publication JP-A-63-223825. The specification describes a data-type converting circuit for converting integer data to floating-point data at high speed in a data driven-type processing apparatus, the data-type converting circuit comprising: a first converting circuit for converting integer data in two's complement representation to absolute-value representation; a second converting circuit, to which a signal representing the sign of the integer data in absolute-value representation and a signal representing the absolute value are supplied, for converting the integral value represented by the input signals to floating-point representation and outputting the sign and absolute value of a mantissa as well as the sign and absolute value of an exponent; and a selection circuit for selecting, and outputting to an external circuit, the sign and absolute value of the mantissa from the output of the second converting circuit.

### SUMMARY OF THE DISCLOSURE

In digital baseband processing, the bits widths of an I (in-phase) component and Q (quadrature) component of digital data prior to conversion are not that large. The result of adding the bit widths of the exponent and mantissa, which are obtained after conversion of I component and Q component to the floating-point form, taking into consideration the bit precision required in succeeding stages, is not that different from the bit width of the I component or Q component of the symbol data prior to conversion. Consequently, the compression rate is not raised that much merely by a data conversion that relies upon the data-type converting circuit described in the specification of Japanese Patent Kokai Publication JP-A-63-223825 cited above.

Accordingly, an object of the present invention is to provide a symbol data converting circuit capable of raising the data compression rate and of reducing required storage capacity, as well as a receiving apparatus having this symbol-data converting circuit.

The foregoing and other objects are attained by a symbol data converting circuit, in accordance with an aspect of the present invention, which comprises means for comparing I and Q components of entered symbol data; means for normalizing the I and Q components of the symbol data in accordance with a value of whichever of the I and Q components of the symbol data has a larger absolute value; and means for rounding or truncating lower order bits of values obtained as a result of normalization.

A symbol data converting circuit in accordance with one aspect of the present invention preferably comprises first and second exponent value calculation circuits, to which I and Q components, respectively, of symbol data are input, for outputting exponent values of the I and Q components of the symbol data, respectively; a minimum-value calculation circuit, to which are input the exponent values of the I and Q components of the symbol data output from the first and second exponent value calculation circuits, for outputting whichever of the two exponent values is smaller; and first and second shifters for left-shifting the I and Q components, respectively, of the symbol data by an amount equivalent to the exponent value obtained by the minimum-value calculating circuit, and outputting the I and Q components, respectively, of the symbol data after the shift.

A symbol data converting circuit in accordance with another aspect of the present invention comprises first and second exponent value calculation circuits, to which I and Q components, respectively, of symbol data are input, for outputting exponent values of the I and Q components of the symbol data, respectively; a maximum-value calculation circuit, to which are input the exponent values of the I and Q components of the symbol data output from the first and second exponent value calculation circuits, for outputting whichever of the two exponent values is larger; first and second shifters for right-shifting the I and Q components, respectively, of the symbol data by an amount equivalent to the exponent value obtained by the maximum-value calculating circuit, and outputting the I and Q components, respectively, of the symbol data after the shift; and means for concatenating several prescribed higher order bits of each of the I and Q components of the shifted symbol data output from the first and second shifters, respectively, and the exponent value indicating the amount of the shift and for outputting the concatenated result as compressed symbol data.

A symbol data converting circuit in accordance with a further aspect of the present invention comprises first and second absolute-value calculation circuits, to which I and Q components, respectively, of symbol data are input, for outputting absolute values of the I and Q components of the symbol data, respectively; a maximum-value calculation circuit, to which are input the absolute values of the I and Q components of the symbol data output from the first and second absolute-value calculation circuits, for selecting and outputting whichever of the two absolute values is larger; an exponent value calculation circuit for calculating an exponent value of the absolute value output from the maximum-value calculation circuit; first and second shifters for shifting the I and Q components, respectively, of the symbol data by an amount equivalent to the exponent value obtained from the exponent value calculating circuit; first and second rounded-value calculation circuits for applying rounding processing to the symbol data shifted by the first and second shifters, respectively; and means for concatenating values obtained by the rounding processing executed for the first and second rounded-value calculation circuits and the exponent value indicating the amount of the shift and for outputting the concatenated result as compressed symbol data.

The foregoing and other objects are attained by a receiving apparatus in accordance with another aspect of the present invention, which comprises a circuit for outputting I and Q components of symbol data obtained by demodulating a receive signal, which has been received by an antenna, to a baseband signal; a set of circuits which includes a despreader circuit for receiving the I and Q components of the symbol data and executing despread processing upon correlating the I and Q components of the symbol data and a PN(Pseudo Noise) code, the symbol data converting circuit according to the present invention for receiving the I and Q components of the symbol data output from the despreader circuit, a symbol data buffer circuit for storing compressed symbol data output from the symbol data converting circuit, and a weighting circuit for applying weighting conforming to the signal level of each path to an output from the symbol data buffer circuit, a plurality of these sets of circuits being arrayed in parallel; and a combiner, which receives outputs from the plurality of weighting circuits, for outputting a signal obtained by adding these outputs.

Still other objects and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram illustrating a symbol data converting circuit according to an embodiment of the present invention;

FIG. 2 is a block diagram illustrating a symbol data converting circuit according to another embodiment of the present invention;

FIG. 3 is an explanatory view illustrating an example of bit allocation according to an embodiment of the present invention;

FIG. 4 is an explanatory view schematically illustrating an example of specific processing according to an embodiment of the present invention; and

FIG. 5 is a block diagram illustrating a receiving apparatus according to another embodiment of the present invention.

### DESCRIPTION OF THE PREFERRED EMBODIMENTS

Preferred embodiments of the present invention will be described with reference to the drawings. Embodiments of the invention will be described below after describing the principle of operation of a symbol data converting circuit according to the present invention.

A symbol data converting circuit according to the present invention includes: an exponent-value calculation circuit for obtaining a value of an exponent from the value of whichever of an I (in-phase) component and a Q (quadrature) component of symbol data has the larger absolute value; and a normalizing circuit for normalizing both the I and Q components of the symbol data using the exponent value, wherein the symbol data converting circuit outputs the exponent value and a value obtained by applying rounding processing or truncation processing to values of the normalized I and Q components.

A symbol data converting circuit according to a first preferred mode of practicing the present invention has I and Q components (two's complement representation data) of symbol data input thereto for converting these to floating-point representation capable of representing a wide range of values. The symbol data converting circuit includes first and second exponent value calculation circuits (11 and 12) for outputting exponent values of the I and Q components, respectively, of the symbol data; a circuit (13), which receives the exponent values of the I and Q components of the symbol data output from the first and second exponent value calculation circuits (11 and 12), respectively, for selecting and outputting whichever of the two input exponent values corresponds to the component having the larger absolute value; and first and second shifters (14 and 15) for shifting the I and Q components, respectively, of the symbol data by an amount equivalent to the exponent value obtained by the circuit (13), and outputting the I and Q components, respectively, of the symbol data after the shift.

The symbol data converting circuit according to a first preferred mode of practicing the present invention further includes means (16) for concatenating several prescribed higher order bits of each of the I and Q components of the shifted symbol data output from the first and second shifters (14 and 15), respectively, and the exponent value indicating the amount of the shift.

In this mode of practicing the present invention, the circuit (13) that selects and outputs whichever of the two input exponent values corresponds to the component having the larger absolute value comprises, e.g., a minimum-value detection circuit which, if the exponent value of the larger numerical value is small, outputs the smaller exponent value.

A symbol data converting circuit according to a another preferred mode of practicing the present invention comprises first and second absolute-value calculation circuits (21 and 22), to which I and Q components, respectively, of symbol data are supplied, for outputting absolute values of the I and Q components, respectively, of the symbol data; a maximum-value calculation circuit (23), to which are supplied the absolute values of the I and Q components of the symbol data output from the first and second absolute-value calculation circuits (21 and 22), respectively, for selecting and outputting whichever of the two input absolute values is larger; an exponent value calculation circuit (24) for calculating an exponent value of the absolute value output from the maximum-value calculation circuit (23); first and second shifters (25, 26) for shifting the I and Q components, respectively, of the symbol data by an amount equivalent to the exponent value obtained from the exponent value calculation circuit (24); first and second rounded-value calculation circuits (27 and 28) for executing rounding of the symbol data shifted by the first and second shifters, respectively; and means (29) for concatenating rounded values obtained by the first and second rounded-value calculation circuits (27 and 28) and the exponent value indicating the amount of the shift and for outputting the concatenated result as compressed symbol data.

In accordance with the symbol data converting circuit according to the present invention constructed as set forth above, the amount of shift for the purpose of normalization is made common for both the I and Q components by utilizing the correlation between the I and Q components of the symbol data, and the pair of I and Q components of the symbol data is converted to one exponent, a mantissa of the I component and a mantissa of the Q component. By virtue of this arrangement, symbol data can be compressed at a compression rate higher than that of the prior-art technique. The reason for this is that the I and Q components of the symbol data in baseband processing exhibit a high degree of correlation, and the absolute value of I-component error and absolute value of Q-component error are the same regardless of the relationship between the absolute values of the I and Q components. Consequently, the precision of the component having the smaller absolute value is decided by the precision of the component having the larger absolute value. This makes possible the practical utilization of the compression technique according to the present invention.

In a data converting apparatus according to the present invention, two items of data X and Y constituting the real and imaginary parts of complex-number data Z (=X+jY, where j²=−1 holds) both composed of binary digital data, and the apparatus converts this data to floating-point data and outputs the converted data. The apparatus comprises means which receives the two items of data X and Y as inputs for calculating exponent values of respective ones of the two items of data X and Y; means for selecting the exponent value of whichever of these items of data has the larger absolute value; means for adopting the selected exponent value as an exponent value common to the two items of data, shifting each of the two items of data by an amount equivalent to the bits of this exponent value and outputting results of the shift as mantissas of respective ones of the two items of data; and means for outputting the common exponent value and prescribed higher order bits of the two mantissas obtained by the shift as compressed data of the two original items of data X and Y input to the apparatus.

Further, a data converting apparatus according to the present invention comprises means to which the above-mentioned two items of data are input for calculating absolute values of each of the two items of data; means for selecting whichever of these items of data has the larger absolute value; means for calculating the exponent value of the selected item of data; shifting means for adopting the calculated exponent value as an exponent value common to the two items of data and shifting each of the two items of data by an amount equivalent to the bits of this exponent value and outputting the shifted data; means for outputting results of rounding each of the two items of data shifted by the shifting means; and means for outputting the common exponent value and prescribed higher order bits of the result of rounding each of the two items of data as compressed data of the two original items of data X and Y input to the apparatus.

A receiving apparatus according to another preferred mode of practicing the present invention comprises: a circuit (120) for outputting I and Q components of symbol data obtained by demodulating a receive signal, which has been received by an antenna (110), to a baseband signal; a set of circuits which includes a despreader circuit (130) for receiving the I and Q components of the symbol data and executing despread processing upon correlating the I and Q components of the symbol data and a PN code, a symbol data converting circuit (100) according to the present invention for receiving the I and Q components of the symbol data output from the despreader circuit, a symbol data buffer circuit (140) for storing compressed symbol data output from the symbol data converting circuit, and a weighting circuit (150) for applying weighting conforming to the signal level of each path to an output from the symbol data buffer circuit, a plurality (n-number) of these sets of circuits being arrayed in parallel; and an adder (160), which receives outputs from the plurality (n-number) of weighting circuits (150), for outputting a signal obtained by adding these outputs.

Preferred embodiments of the present invention will now be described in detail with reference to the accompanying drawings.

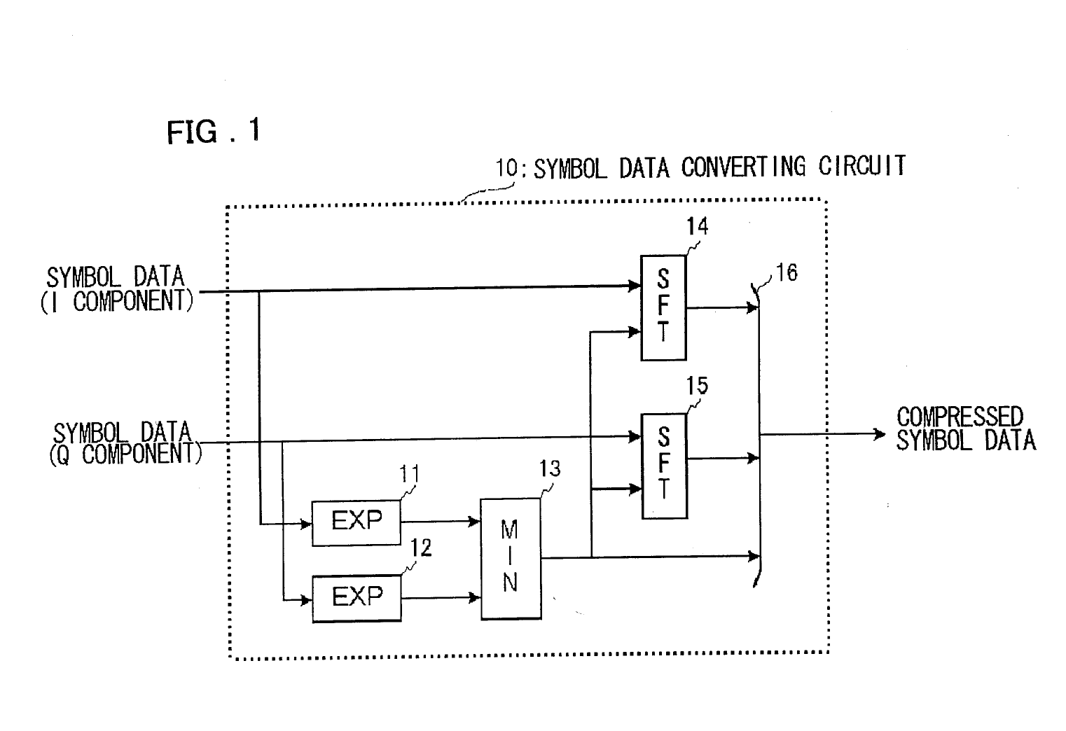

FIG. 1 is a block diagram illustrating a symbol data converting circuit 10 according to a first embodiment of the present invention.

Referring to FIG. 1, the symbol data converting circuit 10 comprises an exponent value calculation circuit (EXP) 11 which calculates the exponent value of an I component of input symbol data; an exponent value calculation circuit (EXP) 12 which calculates the exponent value of a Q component of the input symbol data; a minimum-value calculation circuit (MIN) 13, which receives the two exponent values obtained by the exponent value calculation circuit 11 and exponent value calculation circuit 12, respectively and outputs whichever of the two input exponent values is smaller; a first shifter (SFT) 14 which performs shifting of the I component of the symbol data by an amount equivalent to the exponent value obtained by the minimum-value calculation circuit (MIN) 13; and a second shifter (SFT) which performs shifting of the Q component of the symbol data by an amount equivalent to the exponent value obtained by the minimum-value calculation circuit (MIN) 13.

The exponent value calculation circuit 11 and the exponent value calculation circuit 12, receive the I and Q components, respectively, at their input terminals. Each exponent value calculation circuit subtracts “1” from the number of successive bits starting from the position of the most significant bit (MSB), whose values are the same as that of the MSB, adopts the difference as an exponent value and outputs this exponent value from its output terminal. For example, in case of the seven bits “0001010” expressed in terms of binary representation (two's-complement representation data), there are three successive “0”s starting from the MSB. Hence, the exponent value calculation circuit subtracts “1” from this number (“3”) of successive bits and adopts the difference “2” as the value of the exponent.

The minimum-value calculation circuit 13 receives the exponent value output from the exponent value calculation circuit 11 and the exponent value output from the exponent value calculation circuit 12 at first and second input terminals, respectively, and selects the smaller of these two input exponent values and outputs the selected exponent value from an output terminal. The output terminal of the minimum-value calculation circuit 13 is connected to a control terminal that controls the amount of shift in the shifter 14 and to a control terminal that controls the amount of shift in the shifter 15.

The shifter 14 and 15 receive I and Q components of the input symbol data, respectively, at their input terminals, and receive the output from the minimum-value calculation circuit 13 at their control terminals as the amount of shift. The shifters 14 and 15 shift I and Q components, respectively, of the input symbol data leftward by the entered shift amount (number of bits) and output the results from their output terminals, respectively. For example, in case of the two's-complement data “0001010” of the above-mentioned seven bits, the exponent value is “2”(=“10”). The shifter performs a 2-bit left-shift and the result “0101000” of the shift-operation becomes the mantissa (the most significant bit of the shifted mantissa is the sign bit). The lower order bits are truncated and the prescribed higher order bits are extracted as the mantissa. In this embodiment, according to the specifications of a digital signal processor (DSP) that executes digital baseband processing, the exponent is stipulated as being the value obtained by subtracting “1” from the number of successive bits starting from the most significant bit of the two's-complement data whose values are the same as that of the most significant bit. The exponent having the larger numerical value is construed as being the smaller number.

The operation of the symbol data converting circuit according to this embodiment will be described with reference to FIG. 1.

The I and Q components of the input symbol data are supplied to the exponent value calculation circuits 11 and 12, respectively, whereby the exponent values of the I and Q components, respectively, are derived. Of the exponent values of the I and Q components of the symbol data obtained by the exponent value calculation circuits 11 and 12, respectively, the smaller exponent value is found by the minimum-value calculation circuit 13.

In accordance with the rule described above, the larger the absolute value of the symbol data, the smaller the symbol value. Therefore, the smaller exponent value found by the minimum-value calculation circuit 13 becomes the exponent value of the component having a larger absolute value.

The I and Q components of the symbol data that have entered the shifters 14 and 15, respectively, are left-shifted by an amount equivalent to the exponent value found by the minimum-value calculation circuit 13 (e.g., if the exponent value is “2”, then the components are left-shifted by two bits), whereby shifted I and Q components of the symbol data are obtained. The output circuit 16 concatenates the several higher order bits of each of these shifted I and Q components and the exponent value indicating the amount of shift and outputs the result as compressed symbol data.

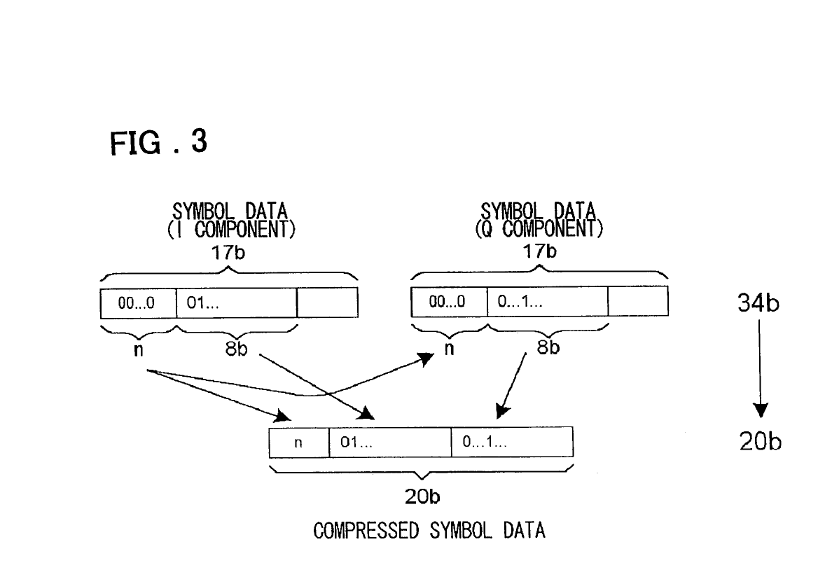

FIG. 3 is a diagram useful in describing the operating principle of this embodiment of the present invention. FIG. 3 illustrates one example of the number of bits of entered symbol data and the number of bits of output symbol data after it has been compressed. In the example of FIG. 3, the I and Q components of the entered symbol data are each 17-bit numbers of two's complements, and the bit precision of the mantissas of the output symbol data is eight bits.

As a result, the compressed symbol data which is output is composed of 20 bits. Thus, the 34 bits (17+17=34) of data before compression are reduced by 14 bits.

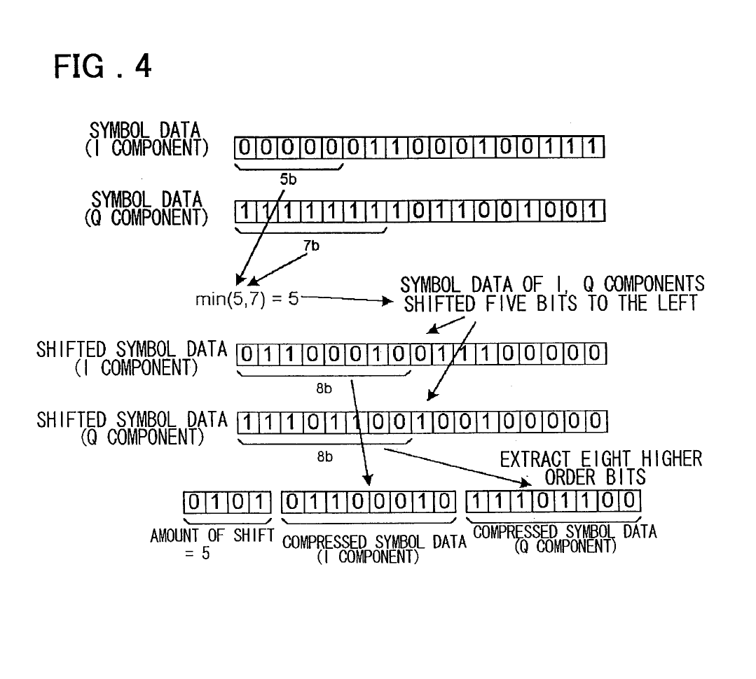

FIG. 4 is an explanatory view illustrating an example of conversion processing for a case employing specific values. First, it is assumed that a two's complement “00000011000100111” of a binary number is given as the I component of symbol data and that a two's complement “11111111011001001” of a binary number is given as the Q component of the symbol data.

The number of successive bits starting from the position of the most significant bit (MSB) of the I component of the symbol data having the same value, i.e., “0”, as that of the MSB is “6”. The exponent value of the I component of the symbol data, therefore is “5” (the exponent value calculation circuit 11 outputs “5”).

Similarly, the number of successive bits starting from the position of the most significant bit (MSB) of the Q component of the symbol data having the same value, i.e., “1”, as that of the MSB is “8”. The exponent value of the Q component of the symbol data, therefore is “7” (the exponent value calculation circuit 12 outputs “7”).

The minimum-value calculation circuit 13 compares the exponent value “5” of the I component and the exponent value “7” of the Q component received from the exponent value calculation circuit 11 and exponent value calculation circuit 12, respectively. Since “5” is the smaller value, the minimum-value calculation circuit 13 adopts the exponent value “5” as the amount of shift and outputs this exponent value to the shifters 14 and 15. The shifters 14 and 15 shift the symbol-data Q and I components, respectively, by five bits to the left (the number of bits ascribable to the exponent value “5”).

The I component of the symbol data after the shift operation by the shifter 14 is the two's complement “01100010011100000” of a binary value, and the Q component of the symbol data after the shift by the shifter 15 is the two's complement “11101100100100000” of a binary value.

If the eight higher order bits are extracted from each of these shifted components of the symbol data, the I component of the symbol data after compression will be “01100010” and the Q component of the symbol data after compression will be “11101100”.

The binary number “0101” indicating the exponent value “5” serving as the amount of shift is concatenated with the bits of these Q components, and I as a result of which the value “01010110001011101100” is obtained. This is the symbol data (20-bit data) after compression. The compressed symbol data (20-bit data) is stored in a symbol data buffer circuit (not shown) as the I and Q components of the symbol data. In a case where the I and Q components of the symbol data are read out of the symbol data buffer circuit (not shown) and processed, the I component of the symbol data is composed of the binary number “0101” constituting the four bits that start with the most significant bit of the 20-bit data and the next eight bits “01100010”, and the Q component of the symbol data is composed of the binary number “0101” constituting the four bits that start with the most significant bit of the 20-bit data and the next eight bits “11101100”. As stated above, data compression in this embodiment is an irreversible type compression.

This embodiment illustrates a case where the larger the exponent value obtained from the components of the symbol data, the smaller the value. However, in a case where the definition is such that the larger the exponent value obtained from the components of the symbol data, the larger the value, similar processing and similar actions and effects can be realized by replacing the minimum-value calculation circuit 13 of FIG. 1 with a maximum-value calculation circuit and replacing the left-shifters with right-shifters.

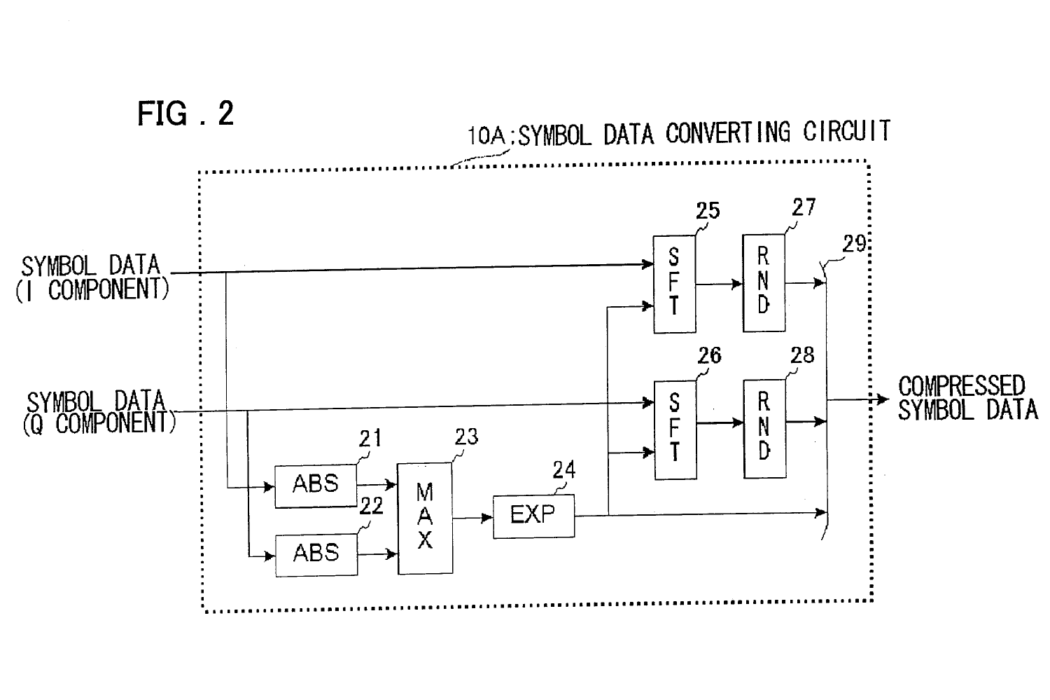

FIG. 2 is a block diagram showing a symbol data converting circuit 1OA according to another embodiment of the invention. This embodiment uses a technique different from that of the above-described embodiment as the technique for calculating the exponent value of a component having the larger absolute value. Further, rounding processing rather than truncation is applied to the data that has been shifted.

Referring to FIG. 2, the symbol data converting circuit 10A comprises an absolute-value calculation circuit (ABS) 21 which calculates the absolute value of an I component of input symbol data; an absolute-value calculation circuit (ABS) 22 which calculates the absolute value of a Q component of the input symbol data; a maximum-value calculation circuit (MAX) 23 which selects the larger of the two absolute values obtained by the absolute-value calculation circuits (ABS) 21 and 22; an exponent value calculation circuit (EXP) 24 which calculates the exponent value of this absolute value; a shifter (SFT) 25, to which the I component of the symbol data is input, and which shifts the I component of the symbol data by an amount equivalent to the exponent value (bits) obtained from the exponent value calculation circuit (MIN) 24; a shifter (SFT) 26, to which the Q component of the symbol data is input, and shifts the Q component of the symbol data by an amount equivalent to the exponent value obtained from the exponent value calculation circuit (MIN) 24; a rounded-value calculation circuit (RND) 27 which executes rounding of the I component of the symbol data shifted by the shifter 25; and a rounded-value calculation circuit (RND) 28 which executes rounding of the Q component of the symbol data shifted by the shifter 26.

The operation of this embodiment will now be described.

First, the I and Q components of the input symbol data are supplied to the absolute-value calculation circuits 21 and 22, respectively, whereby the absolute values of the symbol-data I and Q components, respectively, are calculated.

The absolute values of the symbol data found by the absolute-value calculation circuits 21 and 22, respectively, are supplied to the maximum-value calculation circuit 23.

Of the two absolute values, the larger absolute value is obtained by the maximum-value calculation circuit 23.

The absolute value of the component having the larger value obtained by the maximum-value calculation circuit 23 is supplied to the exponent value calculation circuit 24, whereby the exponent value of the component having the larger absolute value is found.

The I and Q components of the symbol data supplied to the shifters 25 and 26, respectively, are left-shifted by an amount equivalent to the exponent value found by the exponent value calculation circuit 24, whereby shifted I and Q components of the symbol data are obtained.

The shifted I and Q components of the symbol data have their values rounded by the rounded-value calculation circuits 27 and 28, respectively, and an output circuit 29 concatenates the rounded values and the exponent value (the output of the exponent value calculation circuit 24) indicating the amount of shift. The concatenated values are output as compressed symbol data. The rounded-value calculation circuits 27 and 28 output, as rounded results, numerical values of prescribed numbers of bits nearest to the original numerical values (the shifted I and Q components of the symbol data).

In a case where rounding processing is executed, the circuitry is larger in scale but is obtained data having a precision higher than in the case where a uniform truncation is applied.

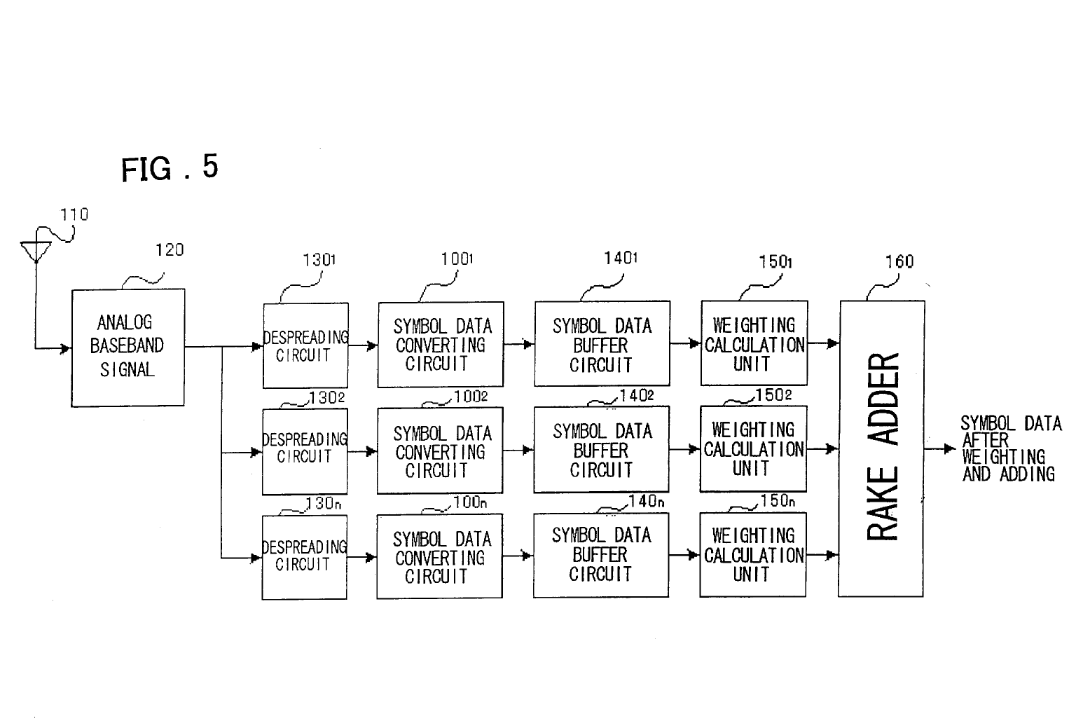

FIG. 5 is a block diagram illustrating the structure of a receiving apparatus having a symbol data converting circuit described above with reference to FIGS. 1 and 2. The apparatus constructs a RAKE receiver employed in CDMA. This RAKE receiver establishes in-phase relationship among the outputs of correlators (also referred to as despreading circuits or fingers) that perform despreading, applies weighting that is proportional to the signal levels of the respective branches and subjects the power of each path to maximal ratio combining. In FIG. 5, an analog baseband signal 120 demodulates the signal received by an antenna 110 to a baseband signal (quadraturede-modulates the signal to the I and Q components) and outputs digital data (the I and Q components), which comprises two's complements), from A/D converters (not shown). The apparatus further includes n number of parallel-arrayed despreading circuits 1301 to 130n , which compose multiple fingers of the RAKE receiver. A searcher (not shown) measures a delay profile (peak power and the delay time thereof) based upon a received pilot signal and sets the amount of delay in each finger. Each of the despreading circuits 1301 to 130n receives the I and Q components of the symbol data output from the analog baseband circuit 120, correlates the components and a PN code (despreading code) at the signal delays set respectively by the searcher (not shown) and performs despreading. Symbol data converting circuits 1001 to l00n , which are provided in correspondence with respective ones of the despreading circuits 1301 to 130n , receive binary data (two's complement representation) of the I and Q components from respective ones of the despreading circuits, effect a conversion to floating-point representation and output a common exponent value and two mantissas, which have been obtained by truncation or rounding, as the I and Q components of the symbol data. Symbol data buffer circuits 1401 to 140n each having a write port and a read-out port are provided in correspondence with respective ones of the symbol data converting circuits 1001 to l00n . The symbol data buffer circuits 1401 to 140n store compressed data output from the symbol data converting circuits 1001 to l00n , respectively. Weighting calculation units 1501 to 150n provided for each of the paths read the common exponent value, the mantissa of the I component of the symbol data and the mantissa of the Q component out of respective ones of the symbol data buffer circuits 1401 to 140n , generate a common exponent value and mantissa with regard to the I component of the symbol data as well as a common exponent value and mantissa with regard to the Q component of the symbol data, and apply weighting that is proportional to the signal levels of the respective paths (branches) to the generated I and Q components of the symbol data. A RAKE adder 160 outputs a value that is the result of adding the output signals from the plurality of weighting calculation units 1501 to 15On , thereby performing maximal ratio combining.

Though the present invention has been described in accordance with the foregoing embodiments, the invention is not limited to these embodiments and it goes without saying that the invention covers various modifications and changes that would be obvious to those skilled in the art within the scope of the claims. For example, in connection with the conversion from two mutually correlated items of data in two's complement representation to data in floating-point representation in the above-described embodiment, compression for extracting one common exponent and two mantissas is illustrated. However, it is permissible to adopt an arrangement in which a common exponent is extracted with regard to two items of data in floating-point representation, normalization is performed by one of these items of data and the normalized two mantissas and common exponent are output as compressed data that is the result of compressing the two original items of data. Further, in connection with the conversion from two items of data in two's complement representation to data in floating-point representation, the foregoing embodiment is such that a value obtained by subtracting 1 from a number of successive bits starting from the MSB and having the same value as the MSB is adopted as the exponent value. However, the invention can be applied similarly even with regard to a floating-point representation format compliant with the IEEE standard, e.g., a single precision floating-point number [if the MSB (0th bit) is a sign bit S, 1st to 8th bits constitute an exponent E and 9th to 31st bits constitute a mantissa M, then value=(−1)^{S}×2^{E-E0}×1.M, where E0=127 holds].

The meritorious effects of the present invention are summarized as follows.

Thus, in accordance with the present invention as described above, the arrangement is such that normalization is carried out in conformity with the larger absolute value of the absolute values of the I and Q components of symbol data, and the I and Q components of the symbol data are converted to a single common exponent and two mantissas, thereby compressing the symbol data efficiently. When this compressed symbol data is stored in a buffer circuit, therefore, the storage capacity needed to store the symbol data can be reduced. In accordance with the present invention, it is possible to suppress an increase in the storage capacity of a symbol data buffer memory, thereby making it possible to deal with a increase in the transfer rate of symbol data.

As many apparently widely different embodiments of the present invention can be made without departing from the spirit and scope thereof, it is to be understood that the invention is not limited to the specific embodiments thereof except as defined in the appended claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A symbol data converting circuit, provided in a digital baseband processing circuit, for converting symbol data applied thereto, said symbol data converting circuit comprising:
means for comparing in-phase and quadrature components of the symbol data;
means for performing normalization of the in-phase and quadrature components of the symbol data, based upon a value of whichever of the I and Q components of the symbol data has a larger absolute value; and
means for performing rounding or truncation of lower order bits of values obtained as a result of the normalization of the in-phase and quadrature components of the symbol data.

2. The circuit according to claim 1, wherein a symbol data which is subjected to rounding or truncation of lower order bits of the value obtained as a result of normalization is stored in a memory.

3. A symbol data converting circuit comprising:
a first exponent value calculation circuit, which receives an in-phase component of symbol data as an input, for obtaining and outputting an exponent value of the in-phase component of the symbol data;
a second exponent value calculation circuit, which receives a quadrature component of the symbol data as an input, for obtaining and outputting an exponent value of the quadrature component of the symbol data;
a circuit, which receives the exponent values of the in-phase and quadrature components of the symbol data output from said first and second exponent value calculation circuits, respectively, for selecting and outputting whichever of the two input exponent values corresponds to the component having the larger absolute value;
a first shifter, which receives the in-phase component of the symbol data, for shifting the in-phase component of the symbol data based upon the exponent value selected; and
a second shifter, which receives the quadrature component of the symbol data, for shifting the quadrature component of the symbol data based upon the exponent value selected.

4. A symbol data converting circuit comprising:
a first absolute-value calculation circuit, which receives an in-phase component of symbol data as an input, for obtaining and outputting absolute value of the in-phase component of the symbol data;
a second absolute-value calculation circuit, which receives a quadrature component of symbol data as an input, for obtaining and outputting absolute values of the quadrature component of the symbol data;
a selection circuit, which receives the absolute values of the in-phase and quadrature components of the symbol data output from said first and second absolute-value calculation circuits, respectively, for selecting and outputting whichever of the two input absolute values is larger;
an exponent value calculation circuit for calculating an exponent value of the larger absolute value selected;
a first shifter, which receives the in-phase component of the symbol data, for shifting the in-phase component of the symbol data based upon the exponent value calculated;
a second shifter, which receives the quadrature component of the symbol data, for shifting the quadrature component of the symbol data based upon the exponent value calculated;
a first rounded-value calculation circuit for rounding the shifted in-phase component of the symbol data output from said first shifter to predetermined numbers of bits and for outputting a result of the rounding; and
a second rounded-value calculation circuit for rounding the shifted quadrature component of the symbol data output from said second shifter to predetermined numbers of bits and for outputting a result of the rounding.

5. A symbol data converting circuit comprising:
a first exponent value calculation circuit, which has an input terminal, from which an in-phase component of symbol data is input, for obtaining an exponent value of the input in-phase component of the symbol data and outputting the obtained exponent value from an output terminal;
a second exponent value calculation circuit, which has an input terminal, from which a quadrature component of symbol data is input, for obtaining an exponent value of the input quadrature component of the symbol data and outputting the obtained exponent value from an output terminal;
a minimum-value calculation circuit, which has first and second input terminals, from which are respectively input the exponent values of the in-phase and quadrature components of the symbol data output from the output terminals of said first and second exponent value calculation circuits, respectively, for outputting from an output terminal whichever of the two input exponent values is smaller;
a first shifter, which has a first input terminal from which the in-phase component of the symbol data is input and a second input terminal from which the exponent value calculated by said minimum-value calculation circuit is input, for shifting the in-phase component of the symbol data by an amount in bits equivalent to the exponent value and for outputting the shifted in-phase component of the symbol data from an output terminal;
a second shifter, which has a first input terminal from which the quadrature component of the symbol data is input and a second input terminal from which the exponent value calculated by said minimum-value calculation circuit is input, for shifting the quadrature component of the symbol data by an amount in bits equivalent to the exponent value and for outputting the shifted quadrature component of the symbol data from an output terminal; and
output means, which receives the shifted in-phase component of the symbol data and the shifted quadrature component of the symbol data output from the output terminals of said first and second shifters, respectively, and he exponent value output from said minimum-value calculation circuit, for concatenating a predetermined number of higher order bits of the shifted in-phase component of the symbol data, a predetermined number of higher order bits of the shifted quadrature component of the symbol data, and the exponent value and for outputting the result of concatenation as compressed symbol data.

6. A symbol data converting circuit comprising:
a first exponent value calculation circuit, which has an input terminal from which an in-phase component of symbol data is input, for obtaining an exponent value of the input in-phase component of the symbol data and outputting this exponent value from an output terminal;
a second exponent value calculation circuit, which has an input terminal from which a quadrature component of symbol data is input, for obtaining an exponent value of the input quadrature component of the symbol data and outputting this exponent value from an output terminal;
a maximum-value calculation circuit, which has first and second input terminals from which are respectively input the exponent values of the in-phase and quadrature components of the symbol data output from the output terminals of said first and second exponent value calculation circuits, for outputting from an output terminal whichever of the two input exponent values is larger;
a first shifter, which has a first input terminal from which the in-phase component of the symbol data is input and a second input terminal from which the exponent value calculated by said maximum-value calculation circuit is input, for shifting the in-phase component of the symbol data by an amount in bits equivalent to the exponent value and for outputting the shifted in-phase component of the symbol data from an output terminal;
a second shifter, which has a first input terminal from which the quadrature component of the symbol data is input and a second input terminal from which the exponent value calculated by said maximum-value calculation circuit is input, for shifting the quadrature component of the symbol data by an amount in bits equivalent to the exponent value and for outputting the shifted quadrature component of the symbol data from an output terminal; and
output means, which receives the shifted in-phase component of the symbol data and the shifted quadrature component of the symbol data output from the output terminals of said first and second shifters, respectively, and the exponent value output from said maximum-value calculation circuit, for concatenating a predetermined number of higher order bits of the shifted in-phase component of the symbol data, a predetermined number of higher order bits of the shifted quadrature component of the symbol data, and the exponent value, and for outputting the result of concatenation as compressed symbol data.

7. A symbol data converting circuit comprising:
a first absolute-value calculation circuit, which has an input terminal from which an in-phase component of symbol data is input, for outputting an absolute value of the in-phase component of the symbol data from an output terminal;
a second absolute-value calculation circuit, which has an input terminal from which a quadrature component of symbol data is input, for outputting an absolute value of the a quadrature component of the symbol data from an output terminal;
a maximum-value calculation circuit, which has first and second input terminals from which are respectively input the absolute values of the in-phase and quadrature components of the symbol data output from the output terminals of said first and second absolute-value calculation circuits, respectively, for selecting and outputting from an output terminal whichever of the two input absolute values is larger;
an exponent value calculation circuit, which has an input terminal from which the absolute value output from the output terminal of said maximum-value calculation circuit is input, for calculating the exponent value of this absolute value and outputting this absolute value from an output terminal;
a first shifter, which has a first input terminal from which the in-phase component of the symbol, data is input and a second input terminal from which the exponent value output from the output terminal of said exponent value calculation circuit is input, for shifting the in-phase component of the symbol data by an amount equivalent to the exponent value;
a second shifter, which has a first input terminal from which the quadrature component of the symbol data is input and a second input terminal from which the exponent value output from the output terminal of said exponent value calculation circuit is input, for shifting the quadrature component of the symbol data by an amount equivalent to the exponent value;
a first rounded-value calculation circuit, which has an input terminal from which the shifted in-phase component of the symbol data output from the output terminal of said first shifter is input, for rounding the shifted in-phase component of the symbol data to a predetermined number of bits and for outputting a result of the rounding from an output terminal;
a second rounded-value calculation circuit, which has an input terminal from which the shifted quadrature component of the symbol data output from the output terminal of said second shifter is input, for rounding the shifted quadrature component of the symbol data to a predetermined number of bits and for outputting a result of the rounding from an output terminal; and
output means, which receives first and second rounded values output from the output terminals of said first and second rounded-value calculation circuits, respectively, and the exponent value, which represents an amount of bit-shifting, output from said exponent value calculation circuit, for concatenating prescribed numbers of higher order bits of the first and second rounded values and the exponent value, and for outputting the result of concatenation as compressed symbol data.

8. The circuit according to claim 1, wherein the in-phase and quadrature components of the input symbol data each is comprised of two's-complement representation data.

9. A CDMA receiving apparatus comprising:
a circuit for outputting in-phase and quadrature components of symbol data obtained by demodulating a receive signal, which has been received by an antenna, to a baseband signal;
a set of circuits which includes:
a despreader circuit for receiving the in-phase and quadrature components of the symbol data and executing despread processing upon correlating the in-phase and quadrature components of the symbol data and a PN code;
the symbol data converting circuit, as defined in claim 1, for receiving the in-phase and quadrature components of the symbol data output from said despreader circuit;
a symbol data buffer circuit for storing compressed symbol data output from said symbol data converting circuit; and
a weighting circuit for applying weighting conforming to a signal level of each path to an output from said symbol data buffer circuit;
a plurality of these sets of circuits being arrayed in parallel; and
an adder, which receives outputs from the plurality of said weighting circuits, for outputting a signal obtained by adding these outputs.

10. A CDMA receiving apparatus comprising:
a circuit for outputting in-phase and quadrature components of symbol data obtained by demodulating a receive signal, which has been received by an antenna, to a baseband signal;
a set of circuits which includes:
a despreader circuit for receiving the in-phase and quadrature components of the symbol data and executing despread processing upon correlating the in-phase and quadrature components of the symbol data and a PN code;
the symbol data converting circuit, as defined in claim 3, for receiving the in-phase and quadrature components of the symbol data output from said despreader circuit;
a symbol data buffer circuit for storing compressed symbol data output from said symbol data converting circuit; and
a weighting circuit for applying weighting conforming to a signal level of each path to an output from said symbol data buffer circuit;
a plurality of these sets of circuits being arrayed in parallel; and
an adder, which receives outputs from the plurality of said weighting circuits, for outputting a signal obtained by adding these outputs.

11. A CDMA receiving apparatus comprising:
a circuit for outputting in-phase and quadrature components of symbol data obtained by demodulating a receive signal, which has been received by an antenna, to a baseband signal;
a set of circuits which includes:
a despreader circuit for receiving the in-phase and quadrature components of the symbol data and executing despread processing upon correlating the in-phase and quadrature components of the symbol data and a PN code;
the symbol data converting circuit, as defined in claim 4, for receiving the in-phase and quadrature components of the symbol data output from said despreader circuit;
a symbol data buffer circuit for storing compressed symbol data output from said symbol data converting circuit; and
a weighting circuit for applying weighting conforming to a signal level of each path to an output from said symbol data buffer circuit;
a plurality of these sets of circuits being arrayed in parallel; and
an adder, which receives outputs from the plurality of said weighting circuits, for outputting a signal obtained by adding these outputs.

12. A CDMA receiving apparatus comprising:
a circuit for outputting in-phase and quadrature components of symbol data obtained by demodulating a receive signal, which has been received by an antenna, to a baseband signal;
a set of circuits which includes:
a despreader circuit for receiving the in-phase and quadrature components of the symbol data and executing despread processing upon correlating the in-phase and quadrature components of the symbol data and a PN code;
the symbol data converting circuit, as defined in claim 5, for receiving the in-phase and quadrature components of the symbol data output from said despreader circuit;
a symbol data buffer circuit for storing compressed symbol data output from said symbol data converting circuit; and
a weighting circuit for applying weighting conforming to a signal level of each path to an output from said symbol data buffer circuit;
a plurality of these sets of circuits being arrayed in parallel; and
an adder, which receives outputs from the plurality of said weighting circuits, for outputting a signal obtained by adding these outputs.

13. A CDMA receiving apparatus comprising:
a circuit for outputting in-phase and quadrature components of symbol data obtained by demodulating a receive signal, which has been received by an antenna, to a baseband signal;
a set of circuits which includes:
a despreader circuit for receiving the in-phase and quadrature components of the symbol data and executing despread processing upon correlating the in-phase and quadrature components of the symbol data and a PN code;
the symbol data converting circuit, as defined in claim 6, for receiving the in-phase and quadrature components of the symbol data output from said despreader circuit;
a symbol data buffer circuit for storing compressed symbol data output from said symbol data converting circuit; and
a weighting circuit for applying weighting conforming to a signal level of each path to an output from said symbol data buffer circuit;
a plurality of these sets of circuits being arrayed in parallel; and
an adder, which receives outputs from the plurality of said weighting circuits, for outputting a signal obtained by adding these outputs.

14. A CDMA receiving apparatus comprising:
a circuit for outputting in-phase and quadrature components of symbol data obtained by demodulating a receive signal, which has been received by an antenna, to a baseband signal;
a set of circuits which includes:
a despreader circuit for receiving the in-phase and quadrature components of the symbol data and executing despread processing upon correlating the in-phase and quadrature components of the symbol data and a PN code;
the symbol data converting circuit, as defined in claim 7, for receiving the in-phase and quadrature components of the symbol data output from said despreader circuit;
a symbol data buffer circuit for storing compressed symbol data output from said symbol data converting circuit; and
a weighting circuit for applying weighting conforming to a signal level of each path to an output from said symbol data buffer circuit;
a plurality of these sets of circuits being arrayed in parallel; and
an adder, which receives outputs from the plurality of said weighting circuits, for outputting a signal obtained by adding these outputs.

15. A circuit for converting data in which two items of data X and Y constituting real and imaginary parts of complex-number data Z (=X+jY, where j²=−1 holds) both comprise binary digital data, said circuit comprising:
means for obtaining exponent values of respective ones of the two items of data X and Y;
means for selecting the exponent value of whichever of these obtained items of data has the larger absolute value;
means for adopting the selected exponent value as an exponent value common to the two items of data, shifting each of the two items of data by an amount in bits equivalent to the exponent value and for outputting results of the shift as mantissas of respective ones of the two items of data; and
means for outputting the common exponent value and prescribed higher order bits of the two mantissas obtained by the shift as compressed data of the two items data input to the circuit.

16. A circuit for converting data in which two items of data X and Y constituting real and imaginary parts of complex-number data Z (=X+jY, where j²=−1 holds) both comprise binary digital data, said circuit comprising:
means, which receives the two items of data X and Y, for obtaining absolute values of respective ones of the two items of data X and Y;
means for selecting whichever of these items of data has the larger absolute value of the two absolute values;
means for obtaining the exponent value of the selected item of data;
shifting means for adopting the obtained exponent value as an exponent value common to the two items of data and shifting each of the two items of data by an amount in bits equivalent to the exponent value and outputting the shifted data;
means for outputting results of rounding each of the two items of data, which have been shifted by said shifting means, as mantissas of respective ones of the two items of data; and
means for outputting the common exponent value and prescribed higher order bits of the two mantissas, obtained as the result of rounding, as compressed data of the two items of data input to the circuit.

17. A CDMA receiving apparatus for individually despreading received signals propagated through respective paths, adjusting phases of signals of respective branches, applying weighing proportional to a signal level of each path to each branch signal and adding the branch signals to thereby achieve diversity combining,
said apparatus including the data converting circuit, as defined in claim 15, inserted between a despreading circuit which receives a signal obtained by demodulating a received signal to a baseband signal and a buffer circuit for temporarily storing a despread signal;
wherein two items of data X and Y constituting real and imaginary parts of complex-number data Z (=X+jY, where j²=−1 holds) are supplied to said data converting circuit from said despreading circuit; and
compressed data output from said data converting circuit is stored in said buffer circuit.

18. A CDMA receiving apparatus for individually despreading received signals propagated through respective paths, adjusting phases of signals of respective branches, applying weighing proportional to a signal level of each path to each branch signal and adding the branch signals to thereby achieve diversity combining,
said apparatus including the data converting circuit, as defined in claim 16, inserted between a despreading circuit which receives a signal obtained by demodulating a received signal to a baseband signal and a buffer circuit for temporarily storing a despread signal;
wherein two items of data X and Y constituting real and imaginary parts of complex-number data Z (=X+jY, where j²=−1 holds) are supplied to said data converting circuit from said despreading circuit; and
compressed data output from said data converting circuit is stored in said buffer circuit.
